(19) United States
(12) Patent Application Publication
(10) Pub. No.: US 2012/0099942 A1
(43) Pub. Date: Apr. 26, 2012

(54) ANCHOR

(75) Inventors: Paul Gaudron, Stratford, CT (US); Jacob Olsen, Roselle, IL (US)

(73) Assignee: POWERS PRODUCTS III, LLC, Brewster, NY (US)

(21) Appl. No.: 12/912,305

(22) Filed: Oct. 26, 2010

(51) Int. Cl. F16B 13/10

(52) U.S. Cl. 411/57.1

(57) ABSTRACT

An anchor is provided and includes a hub having a trailing edge, and first and second jaws, each including a body pivotably coupled to the hub and an actuator to induce pivoting of the body, the jaws being initially proximal with the bodies cooperatively forming a lead profile such that the jaws and the hub are configured to penetrate a substrate, separable responsive to fastener insertion through the hub whereby the fastener exerts a first force on the actuators causing splay pivoting of the bodies, and at least partially closeable responsive to continued fastener insertion whereby the fastener exerts a second force on the actuators causing reverse pivoting of the bodies to draw the trailing edge toward the actuators about the substrate.

### BACKGROUND OF THE INVENTION

The subject matter disclosed herein relates to an anchor for use with a substrate, such as a hollow wall.

It is often necessary to hang an element, such as a relatively heavy wall fixture, onto a substrate, such as a hollow wall or, more particularly, dry wall. If the wall fixture is too heavy or if the fastener used to hang the wall fixture is not properly adapted for the purpose for which it is being used, however, the hanging will not be as secure as it could or should be. The wall fixture could fall as a result or damage to the substrate could ensure.

Anchors for use with hollow walls have, therefore, been relied upon to secure wall fixtures and/or other elements to the hollow walls where fasteners alone would be insecure. A typical one of these anchors is inserted through the hollow wall or through a pilot hole drilled into the hollow wall. The anchor is thereby anchored to the hollow wall and the wall fixture is fixed to the anchor by a fastener. As the anchor often has a relatively large footprint and/or wide mating surfaces, the stresses applied to the hollow wall by the weight of the wall fixture and by the anchor are distributed over relatively wide areas thus permitting a tight coupling with the hollow wall without risking damage to the hollow wall material.

### BRIEF DESCRIPTION OF THE INVENTION

According to one aspect of the invention, an anchor is provided and includes a hub having a trailing edge, and first and second jaws, each including a body pivotably coupled to the hub and an actuator to induce pivoting of the body, the jaws being initially proximal with the bodies cooperatively forming a lead profile such that the jaws and the hub are configured to penetrate a substrate, separable responsive to fastener insertion through the hub whereby the fastener exerts a first force on the actuators causing splay pivoting of the bodies, and at least partially closeable responsive to continued fastener insertion whereby the fastener exerts a second force on the actuators causing reverse pivoting of the bodies to draw the trailing edge toward the actuators about the substrate.

According to another aspect of the invention, an anchor is provided and includes a hub having trailing and leading edges and first and second jaws, each including a body pivotably coupled to the hub leading edge and an actuator to induce pivoting of the body, the jaws being initially proximal with the bodies cooperatively forming a lead profile such that the jaws and the hub are configured to penetrate a substrate, separable responsive to fastener insertion through the hub whereby the fastener exerts a first force on the actuators causing splay pivoting of the bodies, and at least partially closeable responsive to continued fastener insertion whereby the fastener exerts a second force on the actuators causing reverse pivoting of the bodies to draw the trailing edge toward the actuators in a tightening direction about the substrate.

According to yet another aspect of the invention, an anchor for a hollow wall is provided and includes a hub having trailing and leading edges longitudinally separate by a distance substantially similar to a thickness of the hollow wall and first and second jaws, each including a body pivotably coupled to the hub leading edge and an actuator to induce pivoting of the body, the jaws being initially proximal with the bodies cooperatively forming a lead profile such that the jaws and the hub are configured to penetrate a substrate, separable responsive to fastener insertion through the hub whereby the fastener exerts a first force on the actuators causing splay pivoting of the bodies, and at least partially closeable responsive to continued fastener insertion whereby the fastener exerts a second force on the actuators causing reverse pivoting of the bodies to draw the trailing edge toward the actuators in a tightening direction about the substrate.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of an anchor in an initial proximal state;

FIG. 2 is a side view of the anchor of FIG. 1;

FIGS. 3 and 4 are opposite perspective views of the anchor of FIG. 1 in a splayed state;

FIGS. 5 and 6 are opposite axial views of the anchor of FIG. 1 in the splayed state;

FIGS. 7 and 8 are opposite side views of the anchor of FIG. 1 in the splayed state; and

FIGS. 9A-9E are side views illustrating an operation of the anchor of FIG. 1.

The detailed description explains embodiments of the invention, together with advantages and features, by way of example with reference to the drawings.

### DETAILED DESCRIPTION OF THE INVENTION

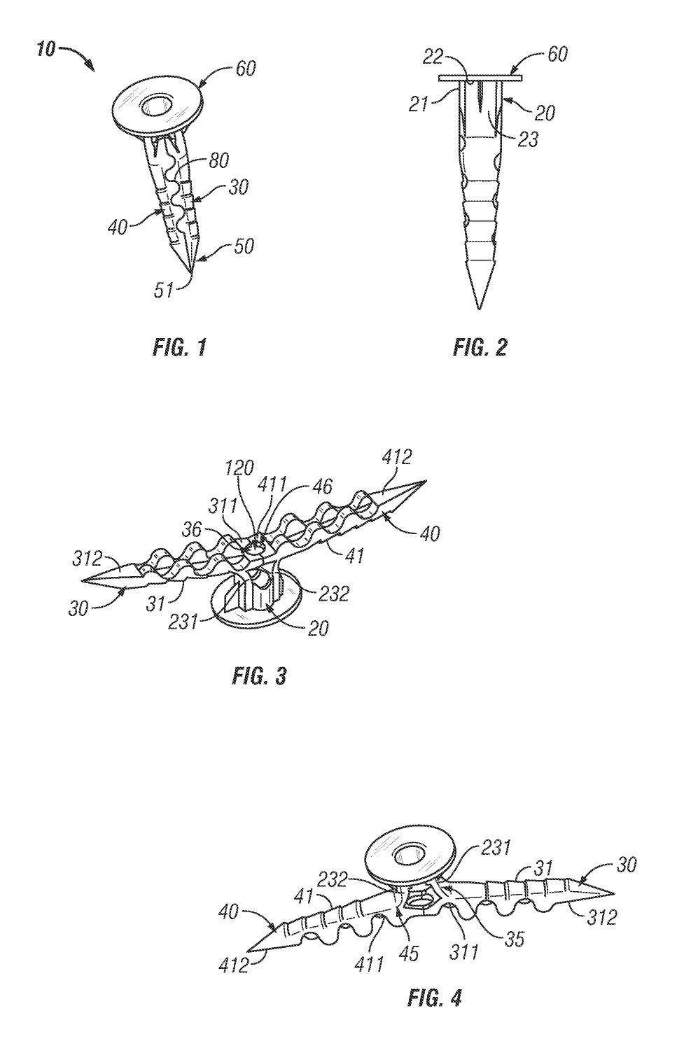

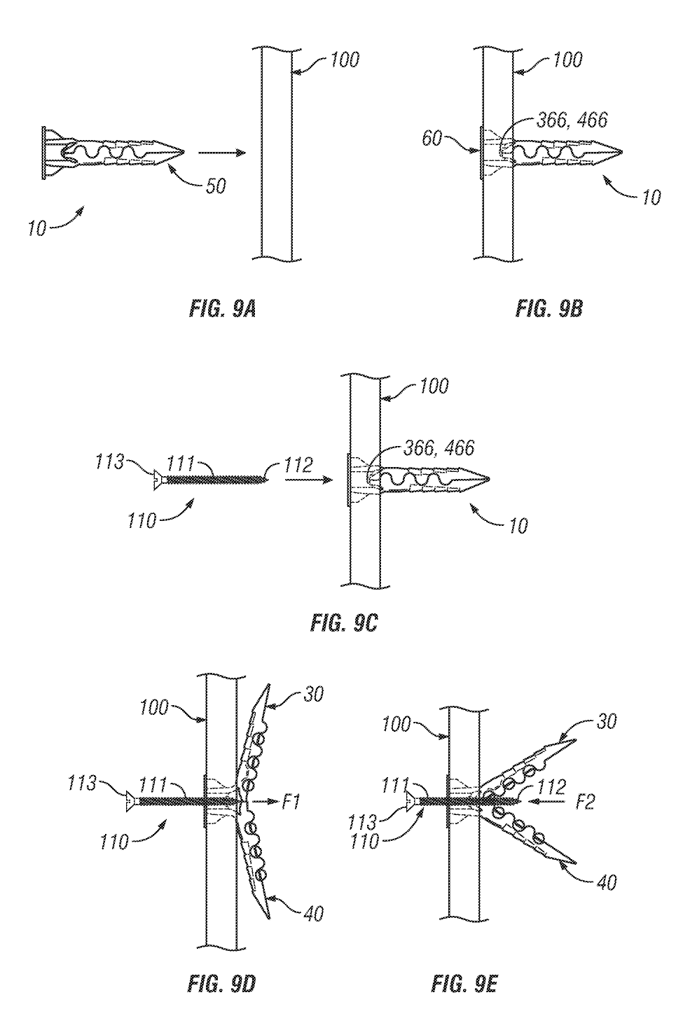

With reference to FIGS. 1-4, an anchor 10 for use with a substrate, such as a hollow wall 100 (see FIGS. 9A-9E) or, more particularly, a hollow dry wall, is provided. The anchor 10 includes a hub 20, a first jaw 30 and a second jaw 40. The hub 20 has a body portion 21, a trailing edge 22 at a trailing side of the body portion 21 and a leading edge 23 at a leading side of the body portion 21. A thickness of the hub 20 should be substantially similar to a thickness of the hollow wall 100 and the trailing edge 22 and the leading edge 23 should be longitudinally separate from one another by a distance that is substantially similar to the hollow wall 100 thickness. Thus, where the anchor 10 is intended for use with a 1 inch thick hollow wall, the hub 20 should be about 1 inch thick and the trailing edge 22 and the leading edge 23 should be about 1 inch apart. By contrast, where the anchor 10 is intended for use with a 1.5 inch thick hollow wall, the hub 20 should be about 1.5 inches thick and the trailing edge 22 and the leading edge 23 should be about 1.5 inches apart.

The first jaw 30 and the second jaw 40 have similar, complementary constructions. For example, the first jaw 30 includes an elongate, tapered first body 31 having a first rear portion 311 and a first forward portion 312. The first rear portion 311 of the first body 31 is pivotably coupled to a first portion 231 of the leading edge 23 and the taper of the first body 31 is defined by the first forward portion 312 being narrower than the first rear portion 311. The second jaw 40 includes an elongate, tapered second body 41 having a second rear portion 411 and a second forward portion 412. The second rear portion 411 of the second body 41 is pivotably coupled to a second portion 232 of the leading edge 23 and the taper of the second body 41 is defined by the second forward portion 412 being narrower than the second rear portion 411.

The first jaw 30 further includes a first hinge 35 and a first actuator 36. The first hinge 35 pivotably couples the first rear portion 311 of the first body 31 to the first portion 231 of the leading edge 23. The first actuator 36 induces pivoting of the first body 31 about the first hinge 35, as will be described below. Similarly, the second jaw 40 further includes a second hinge 45 and a second actuator 46. The second hinge 45 pivotably couples the second rear portion 411 of the second body 41 to the second portion 232 of the leading edge 23. The second actuator 46 induces pivoting of the second body 41 about the second hinge 45, as will also be described below.

The first and second hinges 35, 45 and the first and second actuators 36, 46 are disposed proximate to the first and second rear portions 311, 411 of the first and second bodies 31, 41, respectively. The first and second actuators 36, 46 are disposed between the first and second hinges 35, 45 and cooperatively define impingement surfaces 366, 466 (see FIGS. 9B and 9C). In this way, contact to the impingement surfaces 366, 466 may tend to bias the first and second bodies 31, 41 to rotate about the first and second hinges 35, 45 in opposite directions.

In accordance with an operation of the anchor 10, the first jaw 30 and the second jaw 40 are disposed in an initially proximal state, as shown in FIG. 1, such that the first forward portion 312 of the first body 31 and the second forward portion 412 of the second body 41 cooperatively form a lead profile 50. In some embodiments, the lead profile 50 includes a pointed tip 51. The lead profile 50 should be configured such that the first and second jaws 30 and 40 penetrate into and through the hollow wall 100 with the hub 20 following. The trailing and leading edges 22, 23 of the hub 20 are defined in accordance with a direction of this insertion. In some further embodiments, the penetration may be achieved by manual insertion by an operator that is either unassisted or tool-assisted. The penetration may also be additionally facilitated by the use of a pilot hole pre-drilled into the hollow wall 100 although this is not required as the lead profile 50 can penetrate or cut into the hollow wall 100 without a pilot hole.

The first and second jaws 30, 40 are also separable from one another in response to insertion of a fastener 110 (see FIGS. 9A-9E), such as a screw, through the hub 20 whereby the fastener 110 exerts a first force, F1 (see FIG. 9D), on the first and second actuators 36, 46 causing splay pivoting of the first and second bodies 31, 41 in opposite directions and away from one another. The first and second jaws 30, 40 are also at least partially closeable towards one another in response to continued fastener 110 insertion whereby the fastener 110 exerts a second force, F2 (see FIG. 9E), on the first and second actuators 36, 46 causing reverse pivoting of the first and second bodies 31, 41 in opposite directions and toward one another. This draws the trailing edge 22 of the hub 20 toward the first and second actuators 36, 46 in a tightening direction about the hollow wall 100 and additionally causes the hub 20 to expand radially outwardly into the hollow wall 100 material.

The anchor 10 further comprises a flange 60 disposed at the trailing edge 22 of the hub 20. The flange 60 extends radially outwardly from the hub 20 and, as the hub 20 is inserted through and into the hollow wall 100, is configured to mate with a surface of the hollow wall 100. In so doing, stresses applied to the hollow wall 100 can be distributed over the relatively wide area associated with the flange 60.

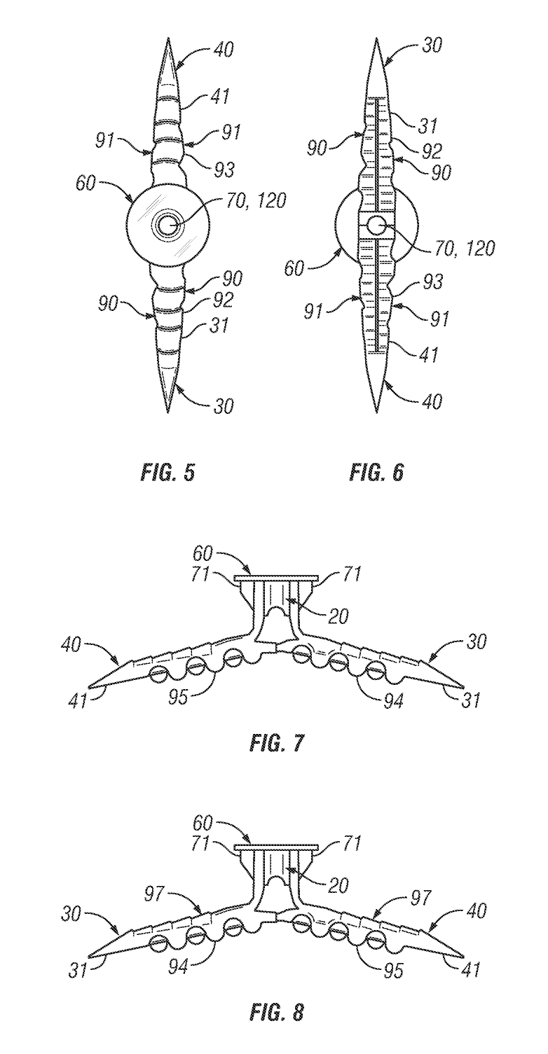

With reference to FIGS. 5-8, the hub 20 is also formed to define a through-hole 70, through which the fastener 110 is insertible and drivable, and the hub 20 further includes anti-rotation features 71. Where the fastener 110 includes a screw, the fastener 110 is inserted through the through-hole 70 by being initially driven and then rotated about its central longitudinal axis. The anti-rotation features 71 may be formed as wings protruding laterally from sides of the hub 20 that drive into and register with the hollow wall 100 material to thereby prevent relative rotation of the hub 20 and the hollow wall 100 about a central longitudinal axis of the hub 20 as the fastener 110 is rotated.

The first and second jaws 30, 40 may be disposed in the initially proximal state by formation of the hub 20, the first body 31 and the second body 41 to have shapes and sizes that are associated with the initially proximal state in which case the initially proximal state would be the natural state of the anchor 10. In accordance with alternate embodiments, the first and second jaws 30, 40 may be biased to splay and, in these case, the anchor 10 may further include an adhesive 80 (see FIG. 1) to bond the first and second jaws 30, 40 at least temporarily in the initially proximal state, which would in this case not be the natural state of the anchor 10. The adhesive 80 may be chosen from a variety of adhesives and should be strong enough to maintain the first and second jaws 30, 40 in the initially proximal state but weak enough to permit separation of the first and second jaws 30, 40 from one another upon insertion of the fastener 110.

The first and second bodies 31, 41 may further include a first set of wings 90 and a second set of wings 91, respectively. As shown in FIGS. 5 and 6, the first and second sets of wings 90, 91 may have complementarily cragged sides 92, 93 that facilitate continued insertion of the jaws 30, 40 into and through the hollow wall 100. Also, as shown in FIGS. 7 and 8, the first and second sets of wings 90, 91 may have complementarily curved mating surfaces 94, 95 that mate with one another when the first and second jaws 30, 40 are in the initially proximal state. The complementarily curved mating surfaces 94, 95 may have sine wave curvatures that are off-phase with one another and serve to increase a tendency of the first and second jaws 30, 40 to remain in the initially proximal state.

In accordance with further embodiments, the first and second bodies 31, 41 may have step formations 97 formed on their opposite outer surfaces. The step formations 97 increase friction with the hollow wall 100 and inhibit movement of the first and second jaws 30, 40 out of the hollow wall.

With reference to FIGS. 9A-9E, an operation of the anchor 10 is illustrated. As shown in FIGS. 9A and 9B, the anchor 10 is provided with the first and second jaws 30, 40 in the initial proximal state and the lead profile 50 formed. The anchor 10 is inserted into and through the hollow wall 100 by an operator who is either unassisted or tool-assisted with the lead profile 50 leading the hub 20 and the insertion is complete when the flange 60 lies flush against the surface of the hollow wall 100, as shown in FIG. 9B.

As shown in FIGS. 9C-9E, a fastener 110 is drivingly inserted through the through-hole 70 and then rotatably inserted further. The fastener 110 should be tightly fit within the through-hole 70 and may include a threaded member 111, a pointed lead tip 112 at a lead end of the threaded member 111 and a head 113 at a trailing end of the threaded member 111. As such, as the fastener 110 is inserted through the through-hole 70, the pointed lead tip 112 contacts the impingement surfaces 366, 466 of the first and second actuators 36, 46, respectively, and thereby exerts the first force, F1, on the first and second actuators 36, 46 in a direction corresponding to a direction of fastener 110 insertion. This causes the first and second bodies 31, 41 to splay pivot away from one another.

With the first and second bodies 31, 41 splayed, the first and second actuators 36, 46 cooperatively define a second through-hole 120 (see FIGS. 5 and 6) through which the fastener 110 is insertible with surfaces of the first and second actuators 36, 46 forming sidewalls of the through-hole 120 upon which the fastener 110 exerts the second force, F2. That is, as the fastener 110 is inserted further, the threading of the threaded member 111 exerts the second force, F2, on the sidewalls of the through-hole 120 formed by the first and second actuators 36, 46 in a direction opposite the fastener insertion direction. The first and second jaws 30, 40 are thereby at least partially closed towards one another and the trailing edge 22 and the flange 60 of the hub 20 are drawn by axial movement of the head 113 toward the first and second actuators 36, 46 in a tightening direction about the hollow wall 100. In addition, insertion of the fastener 110 may cause the hub 20 to expand radially outwardly into the hollow wall 100 material.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An anchor, comprising:
a hub having a trailing edge; and
first and second jaws, each including a body pivotably coupled to the hub and an actuator to induce pivoting of the body, the jaws being:
initially proximal with the bodies cooperatively forming a lead profile such that the jaws and the hub are configured to penetrate a substrate,
separable responsive to fastener insertion through the hub whereby the fastener exerts a first force on the actuators causing splay pivoting of the bodies, and
at least partially closeable responsive to continued fastener insertion whereby the fastener exerts a second force on the actuators causing reverse pivoting of the bodies to draw the trailing edge toward the actuators about the substrate.

2. The anchor according to claim 1, wherein the substrate comprises a hollow wall having a thickness substantially equal to or less than a thickness of the hub.

3. The anchor according to claim 1, wherein trailing edge is defined in accordance with an insertion direction of the jaws and the hub into the substrate.

4. The anchor according to claim 1, further comprises a flange disposed at the hub trailing edge to mate with a surface of the substrate.

5. The anchor according to claim 1, wherein the hub is formed to define a through-hole through which the fastener is insertible.

6. The anchor according to claim 1, further comprising anti-rotation features disposed on the hub to prevent rotation thereof about the fastener.

7. The anchor according to claim 6, wherein the fastener comprises a threaded member for which insertion is achieved by rotation of the member about a longitudinal axis thereof.

8. The anchor according to claim 7, wherein a lead tip of the threaded member exerts the first force on the actuators in a direction of fastener insertion and threading thereof exerts the second force on the actuators in a direction opposite the fastener insertion direction.

9. The anchor according to claim 1, wherein the lead profile comprises a pointed tip.

10. The anchor according to claim 1, wherein the jaws comprise hinges by which the bodies are pivotably coupled to the hub.

11. The anchor according to claim 10, wherein the hinges and the actuators are disposed proximate to rear portions of the bodies, and wherein the actuators are disposed between the hinges.

12. The anchor according to claim 1, wherein the actuators cooperatively define an impingement surface upon which the fastener exerts the first force when the jaws are initially proximal.

13. The anchor according to claim 1, wherein the actuators cooperatively define a through-hole through which the fastener is insertible when the jaws are splayed.

14. The anchor according to claim 13, wherein actuator surfaces form sidewalls of the through-hole upon which the fastener exerts the second force.

15. The anchor according to claim 1, further comprising adhesive to bond the jaws when the jaws are initially proximal.

16. The anchor according to claim 1, wherein the bodies further comprise wings having complementarily curved mating surfaces that mate when the jaws are initially proximal.

17. The anchor according to claim 16, wherein sides of the wings are complementarily cragged.

18. The anchor according to claim 1, wherein the bodies further comprise step formations inhibiting movement of the jaws out of the substrate.

19. An anchor, comprising:
a hub having trailing and leading edges; and
first and second jaws, each including a body pivotably coupled to the hub leading edge and an actuator to induce pivoting of the body, the jaws being:
initially proximal with the bodies cooperatively forming a lead profile such that the jaws and the hub are configured to penetrate a substrate,
separable responsive to fastener insertion through the hub whereby the fastener exerts a first force on the actuators causing splay pivoting of the bodies, and
at least partially closeable responsive to continued fastener insertion whereby the fastener exerts a second force on the actuators causing reverse pivoting of the bodies to draw the trailing edge toward the actuators in a tightening direction about the substrate.

20. An anchor for a hollow wall, comprising:
a hub having trailing and leading edges longitudinally separate by a distance substantially similar to a thickness of the hollow wall; and
first and second jaws, each including a body pivotably coupled to the hub leading edge and an actuator to induce pivoting of the body, the jaws being:
initially proximal with the bodies cooperatively forming a lead profile such that the jaws and the hub are configured to penetrate a substrate,
separable responsive to fastener insertion through the hub whereby the fastener exerts a first force on the actuators causing splay pivoting of the bodies, and
at least partially closeable responsive to continued fastener insertion whereby the fastener exerts a second force on the actuators causing reverse pivoting of the bodies to draw the trailing edge toward the actuators in a tightening direction about the substrate.
